(19) United States
(12) Patent Application Publication
(10) Pub. No.: US 2010/0319507 A1
(43) Pub. Date: Dec. 23, 2010

(54) CUTTING DEVICE

(76) Inventors: James K. Tse, New York, NY (US); Peng Li Ming, Changde (CN); Zhang Zi Peng, Wuhan (CN)

Correspondence Address: OSTROLENK FABER GERB & SOFFEN, 1180 AVENUE OF THE AMERICAS, NEW YORK, NY, 100368403, US

(21) Appl. No.: 12/818,747

(22) Filed: Jun. 18, 2010

Related U.S. Application Data
(60) Provisional application No. 61/218,375, filed on Jun. 18, 2009.

(51) Int. Cl. B26D 3/10; B26D 1/04; B26D 3/12; B26D 7/00

(52) U.S. Cl. 83/56; 83/433; 83/435.11; 83/520; 83/649

(57) ABSTRACT

A cutting device in accordance with an embodiment of the present application allows users to both cut and print on a substrate provided to the device to create any desired design or pattern. The device includes an integral cutting surface, and thus, avoids the need to mount each piece of material to be cut on a cutting mat prior to use. This allows for the inclusion of a multi-page feeding system that allows multiple pages of paper to be continuously fed into the device for cutting and/or printing.

### CROSS-REFERENCE TO RELATED APPLICATION

The present application claims benefit of and priority to U.S. Provisional Patent Application Ser. No. 61/218,375 filed Jun. 18, 2009 entitled CUTTING AND PLOTTING DEVICE, the entire content of which is hereby incorporated by reference herein.

### BACKGROUND

1. Field of the Disclosure

The present disclosure relates to a cutting device configured and operable for cutting and printing on multiple sheets of paper.

2. Related Art

Cutting devices for cutting paper, or other material, into desired shapes have been introduced for use in crafts. One such cutting device is the CRICUT® (A Registered Trademark of Provo Craft and Novelty, Inc.) which allows users to cut a wide range of designs from a single sheet of paper. The CRICUT device includes a cutting mat on which the material to be cut is mounted prior to insertion into the cutting machine. The machine allows the user to select the design to be cut into the material and the size of the paper or other material being provided. The cutting mat and the material to be cut are then fed into the machine and a knife automatically cuts the desired design into the material. Since the material to be cut must be mounted on a cutting pad, only one sheet of material may be provided at a time to the machine. While the CRICUT does allow for printing, in order to do so, the blade must be removed such that cutting and printing cannot be done at the same time.

Another cutting machine is the SLICE™, which is a portable device that is used in conjunction with a glass cutting mat. The material to be cut is mounted on the glass cutting mat and the portable SLICE device is placed on top of the material. The SLICE then cuts a desired design into the material.

While these devices allow for cutting of material into desired designs, in both cases, only one sheet of material can be worked on at a time. If additional designs are desired, each new sheet of material must be manually mounted on the cutting mat and then cut. In addition, glass cutting boards require constant maintenance including constant re-application of glue. Plastic cutting mats will wear out. In addition, in either case, paper size is limited to the size of the cutting mat. Further, the devices discussed above allow for the cutting of material but there is no way to provide for printing and cutting at the same time.

Accordingly it would be desirable to provide a cutting device that avoids these and other problems associated with the prior art cutting devices.

### SUMMARY

It is an object of the present invention to provide a cutting device that is operable to cut and print on several sheets of paper.

The cutting device of the present application preferably includes a single operating head with a blade and a pen, or other printing element, that allows for material to be cut into a desired design and/or printed on.

The cutting device of the present application further includes an integral cutting surface such that the material to be cut need not be mounted on a cutting mat prior to introduction to the device.

The cutting device of the present application further includes a multipage function that allows multiple pages to be fed automatically into the cutting device.

A cutting device in accordance with an embodiment of the present application includes an operational head including a cutting element mounted thereon and a cutting surface for receiving and supporting unsupported paper, the operational head configured to move relative to the paper supported by the cutting surface to cut a desired pattern therein with the cutting element.

A method of cutting paper in accordance with an embodiment of the present application includes feeding unsupported paper into a paper cutting device, supporting the unsupported paper after it has been received in the paper cutting device and cutting the supported paper to provide a desired pattern therein.

A cutting device in accordance with an embodiment of the present application includes an operational head configured to move to a desired position in the cutting device, a cutting surface positioned under the operational head, a paper driver configured to drive paper through the cutting device between the operational head and the cutting surface, wherein the operational head further includes at least one cutting element configured to selectively cut the paper on the cutting surface to provide a desired pattern and a processor configured to control the operational head and the paper driver to position the operational head at the desired position over a desired portion of the paper.

A cutting device in accordance with an embodiment of the present application includes an operational head movable to a desired position in the cutting device, a cutting surface positioned under the operational head, a paper driver configured to drive paper through the cutting device between the operational head and the cutting surface, wherein the operational head further includes at least one cutting element configured to selectively cut the paper on the cutting surface to provide a desired pattern and at least one printing element configured to selectively draw on the paper. The cutting device further including a processor operable to control the operational head and the paper driver to position the operational head in the desired position over the paper and to control the operation of the at least one cutting element and the at least one printing element.

A cutting device in accordance with an embodiment of the present application includes an operational head movable to a desired position in the cutting device, a cutting surface positioned under the operational head, a paper driver configured to drive paper through the cutting device between the operational head and the cutting surface, a paper tray configured to hold a plurality of pieces of paper, wherein the paper driver further includes a feed roller positioned adjacent to the paper tray and configured to rotate to automatically feed the paper into the cutting device from the paper tray, the operational head further including at least one cutting element configured to selectively cut the paper on the cutting surface to provide a desired pattern. The cutting device further including a processor operable to control the operational head and the feed roller to respective desired positions and to operate the cutting element to selectively cut the piece of paper in the desired pattern.

A cutting device in accordance with an embodiment of the present application includes an operational head movable to a desired position in the cutting device, a cutting surface positioned under the operational head, a paper driver configured to drive paper through the cutting device between the operational head and the cutting surface, wherein the operational head further includes at least one cutting element configured to selectively cut the paper on the cutting surface to provide a desired pattern, a processor operable to control the operational head and the paper driver to position the operational head in the desired position over the paper and an input device configured to enable a user to provide information to the processor regarding a desired pattern.

A cutting device in accordance with an embodiment of the present application includes an operational head configured to move to a desired position in the cutting device, a cutting surface positioned under the operational head, a paper driver configured to drive paper through the cutting device between the operational head and the cutting surface and a processor configured to control the operational head and the paper driver to position the operational head at the desired position over a desired portion of the paper, wherein the operational head further includes at least one cutting element configured to selectively cut the paper on the cutting surface to provide a desired pattern, and the processor controls the at least one cutting element to provide a predetermined number of uncut tabs of paper in the desired pattern.

A method of cutting paper with a cutting device in accordance with an embodiment of the present application includes operating a paper driver to drive paper through the cutting device, moving an operational head to a desired position over the paper, providing an integral cutting surface under the operational head and the paper and lowering a cutting blade from the operational head to cut the paper at the desired position based on instructions provided by a processor to provide a desired pattern.

A method of cutting paper with a cutting device in accordance with an embodiment of the present application includes operating a paper driver to drive paper through the cutting device, moving an operational head to a desired position over the paper, providing an integral cutting surface under the operational head and the paper, lowering a cutting blade from the operational head to cut the paper at the desired position based on instructions provided by a processor to provide a desired pattern and printing on the paper using a printing element based on instructions provided by the processor.

A method of cutting paper with a cutting device in accordance with an embodiment of the present application includes providing a paper tray including a plurality of pieces of paper, operating a paper driver to feed paper from the paper tray into the cutting device and drive paper through the cutting device, moving an operational head to a desired position over the paper, providing an integral cutting surface under the operational head and the paper, and lowering a cutting blade from the operational head to cut the paper at the desired position based on instructions provided by a processor to provide a desired pattern.

A method of cutting paper with a cutting device in accordance with an embodiment of the present application includes providing a bracket supporting a roll of paper, operating a paper driver to feed paper from the roll of paper into the cutting device and to drive paper through the cutting device, moving an operational head to a desired position over the paper, providing an integral cutting surface under the operational head and the paper, and lowering a cutting blade from the operational head to cut the paper at the desired position based on instructions provided by a processor to provide a desired pattern.

A method of cutting paper with a cutting device in accordance with an embodiment of the present application includes operating a paper driver to drive paper through the cutting device, moving an operational head to a desired position over the paper, providing an integral cutting surface under the operational head and the paper, lowering a cutting blade from the operational head to cut the paper at the desired position based on instructions provided by a processor to provide a desired pattern and raising the blade selectively while cutting the desired pattern to provide uncut tabs of paper in the desired pattern.

A method of printing on paper utilizing a cutting device having an operational head with a cutting element and a printing element in accordance with an embodiment of the present application includes operating a paper driver to drive the paper through the cutting device, moving the operational head to a desired position over the paper and printing on the paper using a printing element based on instructions provided by a processor.

Other features and advantages of the present invention will become apparent from the following description of the invention which refers to the accompanying drawings.

### BRIEF DESCRIPTION OF THE DRAWINGS

FIG. 1 is a perspective view of a rear of a cutting device in accordance with an embodiment of the present application.

FIG. 1A illustrates the tray of the cutting device of FIG. 1.

FIG. 2 is a perspective view of a front of the cutting device of FIG. 1 with a cover in an open position.

FIG. 3 is a perspective view of the front of the cutting device of FIG. 1 illustrating the addition of a roll of paper.

FIG. 4 is a more detailed view of the hinges used to mount the cover on the cutting device of FIGS. 1-3.

FIG. 5 illustrates the cutting device of FIG. 1 including an access panel provided on a bottom of the device.

FIG. 6 is a more detailed illustration of a drawer included in the device of FIGS. 1-5.

FIG. 7 illustrates a main portion of the cutting device in FIG. 1.

FIG. 8 shows the main portion of the cutting device of FIG. 7 with a rechargeable battery removed.

FIG. 9 is a more detailed illustration of drive rollers used to drive paper through device of FIG. 1.

FIG. 10 is a more detailed view of an operational head and the bracket on which it travels in the device of FIG. 1.

FIG. 11 illustrates a cross sectional view of the bracket of FIG. 10 showing the trolley on which the operational head travels.

FIG. 12 illustrates a rear feed roller used to feed paper from a paper tray of the device of FIG. 1 into the device.

FIG. 13 illustrates a lifting arm used to aid in feeding paper into the device of FIG. 1.

FIG. 14 illustrates a relationship between the lifting arm and a lifting roller that aids in feeding paper into the device of FIG. 1.

FIG. 15 illustrates the rear feed roller of FIG. 12 and a counter roller coupled thereto.

FIG. 16 illustrates interaction of the arm of FIG. 13 with the counter roller of FIG. 15.

FIG. 17 illustrates operation of a front roller that operates to feed paper through the front of the device and to clear paper out of the device.

FIG. 18 1 illustrates an exemplary embodiment of the cutting surface used in the device of FIG. 1

FIG. 19 illustrates how the cutting surface may be turned and flipped in the device of FIG. 1 in order to extend the life thereof.

FIG. 20 illustrates a more detailed view of the operational head of the device of FIG. 1.

FIG. 21 illustrates how the operational head is pivotable on the trolley that moves it along the bracket.

FIG. 22 illustrates a bottom view of the operational head and the trolley.

FIG. 23 illustrates an exploded view of a blade assembly mounted in the operational head.

FIG. 24 illustrates a cross sectional view of the blade assembly.

FIG. 25 illustrates a cross sectional view of the blade assembly including a blade adjustment knob used to adjust the height of the blade.

FIG. 26 illustrates an exploded view of a printing element assembly mounted in the operational head.

FIG. 27 illustrates a front perspective view of a cutting device in accordance with another embodiment of the present application including an inkjet print head.

FIG. 28 illustrates a front perspective view of a cutting device in accordance with another embodiment of the present application including an inkjet print head integrated into the operational head.

FIG. 29 is an exemplary block diagram illustrating how a processor controls the cutting device of the present application.

FIG. 30 is an exploded view of the device of FIG. 1.

### DETAILED DESCRIPTION OF THE EMBODIMENTS

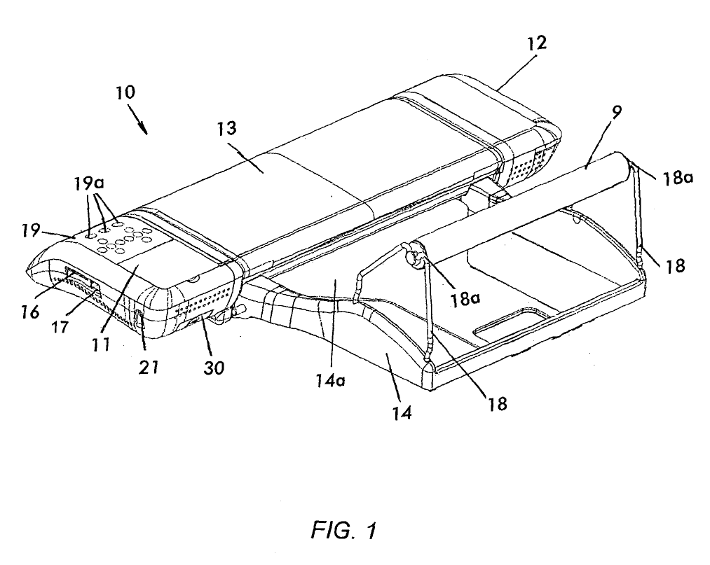

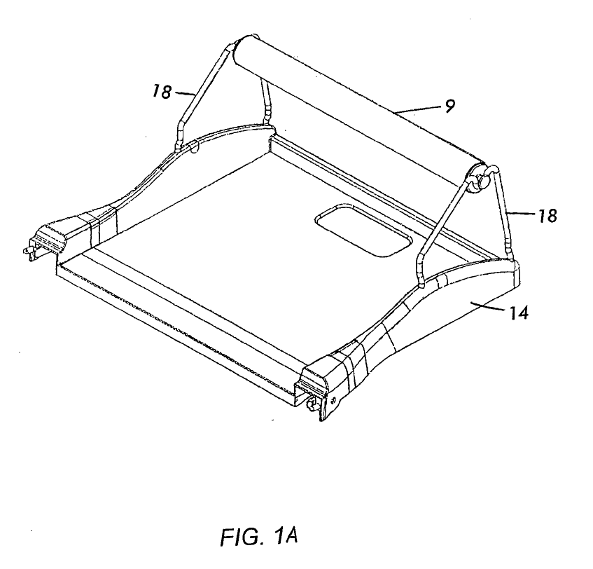

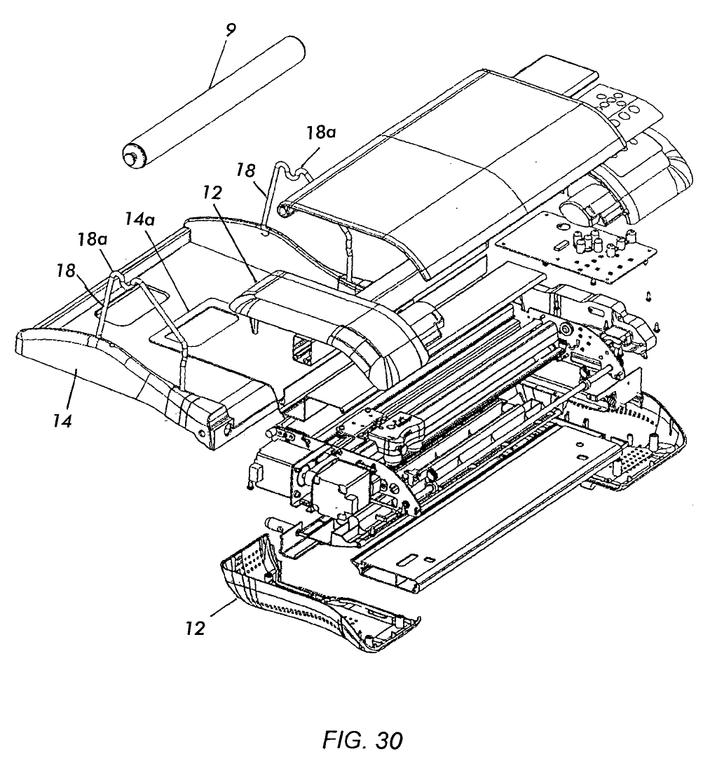

FIG. 1 illustrates an exemplary embodiment of a cutting device 10 in accordance with the present disclosure. FIG. 30 illustrates an exploded view of the device 10 illustrating the orientation of the various elements discussed below to each other. While the device 10 is preferably an electric cutting device, that is, driven by electric motors or other electrically driven actuators, it need not be limited to use with electric actuators. Further, the device 10 is not limited to cutting, but is also may be used to draw or print on materials, such as paper. In the present application, the word paper is used generally, however, the device 10 is suitable for use on a variety of materials, including but not limited to thin cardboard, poster board, foil, vinyl, acrylic, thin plastic, fabric, wood veneer and food, such as fondant, and any other suitable material. Accordingly, the word “paper” as used herein is intended to refer to any, and all of these materials.

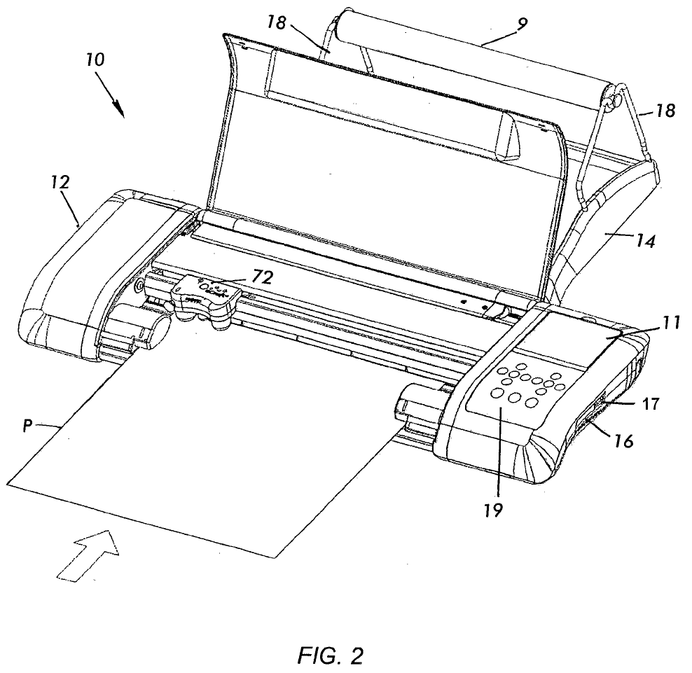

The device 10 preferably includes a housing 12 with a cover 13 movable between a closed position, illustrated in FIG. 1, for example and an open position. See FIG. 2, for example. The device 10 also includes a removable tray 14, preferably mounted in a rear of the device, in which paper can be stacked for feeding into the device. The tray 14 also includes a guide element 14a that supports the paper in the tray 14. The guide 14a moves up and down with the paper in the tray and helps to ensure that the paper remains flat as it is fed into the device 10. This ensures that the paper will feed properly into the device 10.

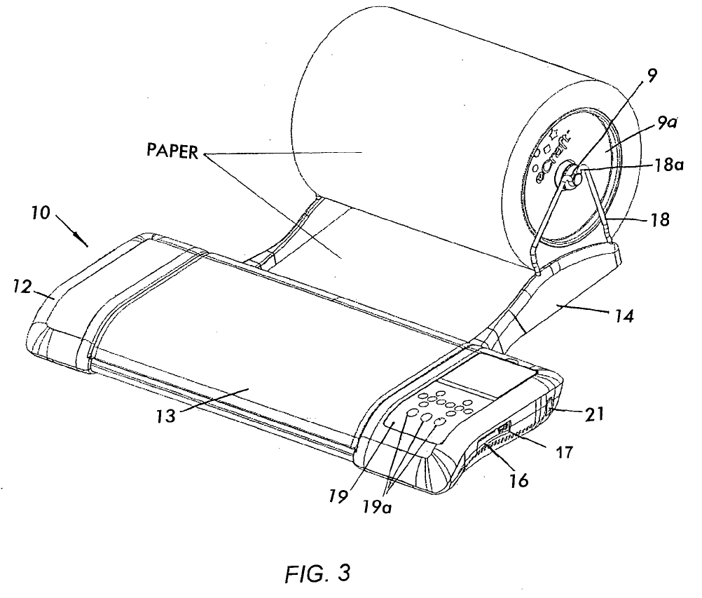

The tray 14 also includes a pair of brackets 18 which are preferably removably mounted thereon to extend upward. A top portion of the each bracket 18 includes a U-shaped recess 18a. The recess 18a is shaped and sized to receive an end of a paper roller 9. The paper roller 9 is positioned between the brackets 18 such that it is rotatable thereon. As can be seen in FIG. 3, the roller 9 may be used with adapters 9a, which allow large rolls of paper to be mounted on the brackets 18. FIG. 1A illustrates the tray 14, including the brackets 18 and the paper roller 9 removed from the rest of the housing 12.

The device 10 also preferably includes a media slot 16, which preferably receives data storage media, such as a SD card or similar data storage device. In this manner, various designs and shapes to be cut by the device 10 may be provided to the device 10 via the data storage medium. While the slot 16 is illustrated as sized to accommodate a SD card, any suitable data storage device may be used. In addition, a USB port 18 may also be provided as well. The USB port 18 allows the device 10 to be connected to a computer, or any similar device including but not limited to cellular telephones, smart phones, MPEG players or other media players, and thus, allows the device to download data, such as additional designs. In the alternative, or in addition, a wireless transceiver may be provided to allow for data to be transferred to the device 10. The USB port 18 thus allows the user to download designs, patterns or other information from the Internet, for example, and then transfer it to the device 10. In this manner, designs and patterns may be purchased on the Internet and easily used in the device 10.

The device 10 also includes an input device 19 that allows the user to input information, including information regarding selection of a desired design and other related parameters. The input device may include one or more buttons or keys 19a that allow the user to input the information and preferences regarding the desired design. Alternatively, or in addition, the input device 19 may include a touch screen to allow user input. The device 10 also includes a display 11 on which the user may view available designs and the selection information discussed above. The LCD 11 may also be a touch screen device. As will be discussed further, these parameters include a mode selection, and sizes and layouts of the selected designs. A power input 21 is provided to connect the device 10 to a power source, as desired.

The device 10 may include drawer 30 that fits in the back of the device 10, as illustrated in FIG. 1. The drawer 30 is preferably configured and designed to hold additional equipment for the device 10, including, but not limited to, additional cutting blades, or elements, 72a and printing elements 72b. In addition, the drawer 30 may be used to store additional storage media such as additional SD cards, for example. In addition, the drawer 30 may be used to hold tools useful in maintaining the device.

FIG. 2 illustrates the device 10 with the cover 13 in an open position. FIG. 2 also illustrates a piece of paper P being fed into the front of the device 10 under the operational head 72. As will be discussed below, paper is fed to the front of the device 10 when the device is operated in MANUAL mode.

FIG. 3 illustrates the device 10 with a large roll of paper mounted on the roller 9. Paper is also shown in the tray 14 as well in FIG. 3. The device 10 is capable of being supplied with paper both from the roll 9, or the tray 14, as desired depending on the mode of operation selected by the user. This is explained in further detail below.

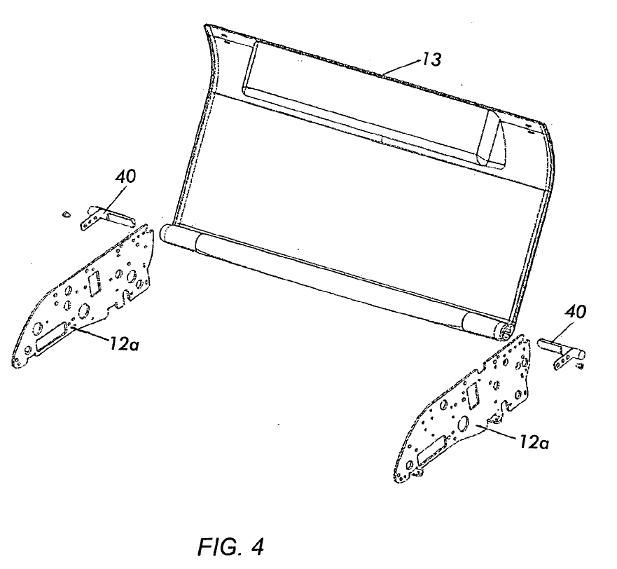

In a preferred embodiment, the cover 13 is attached to the device 10 utilizing hinges 40. See FIG. 4, for example. The hinges 40 are preferably structured such that the cover 13 may be set at any desired position between the closed and open position. The hinges 40 also provide for automatic closure of the cover 13 once the cover approaches the closed position. The hinges are connected to sidewalls 12a, which are mounted in the housing 12. This allows for smoother operation and overall easier use. While the hinges 40 are specifically shown and described herein, any suitable hinges may be used. In addition, the cover may be locked down in the closed position to prevent tampering or unauthorized access, if desired. For example, a C-shaped lock element may be secured to the bottom of the device with an arm extending over the cover to prevent lifting.

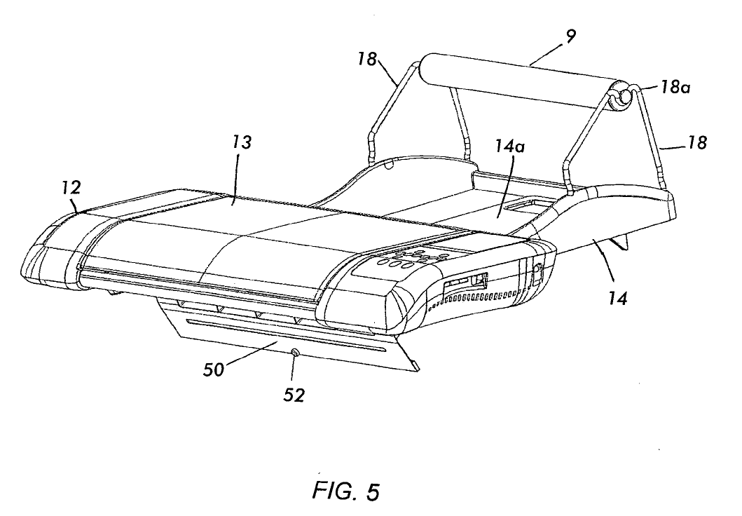

FIG. 5 illustrates an access panel 50 positioned on a bottom of the device 10 that allows a user to access the paper path from below the device 10. This allows the user to clear paper jams, for example. The panel 50 is preferably rotatably connected to the bottom of the device 10. A screw 52, or any other suitable fastener, may be used to fix the panel 50 in place on the device 10 during operation. In the event of a paper jam, or other problem, the fastener 52 may be released to allow the panel to be opened and to allow access to the interior of device 10.

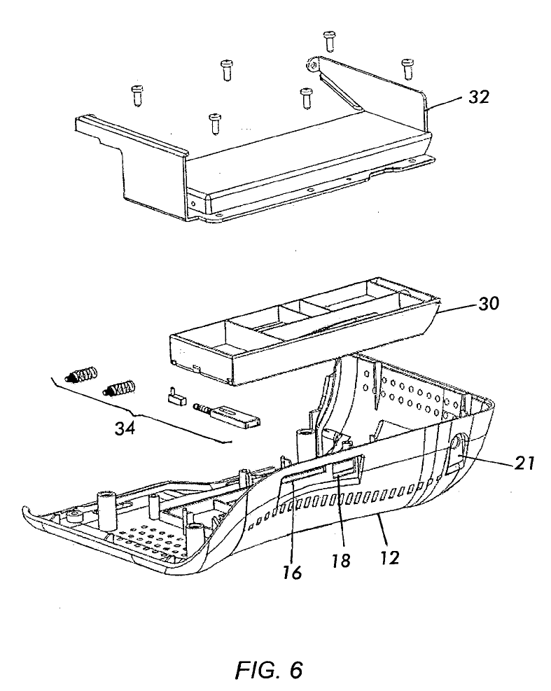

FIG. 6 illustrates a more detailed view of the drawer 30. As illustrated, the drawer is preferably mounted on drawer bracket 32, which is in turn mounted in housing 12. In a preferred embodiment, a latch mechanism 34 is provided to hold the drawer 30 closed after a user pushes it in. To release the latch, the user pushes in again and the drawer 30 is free to slide out of the housing 12.

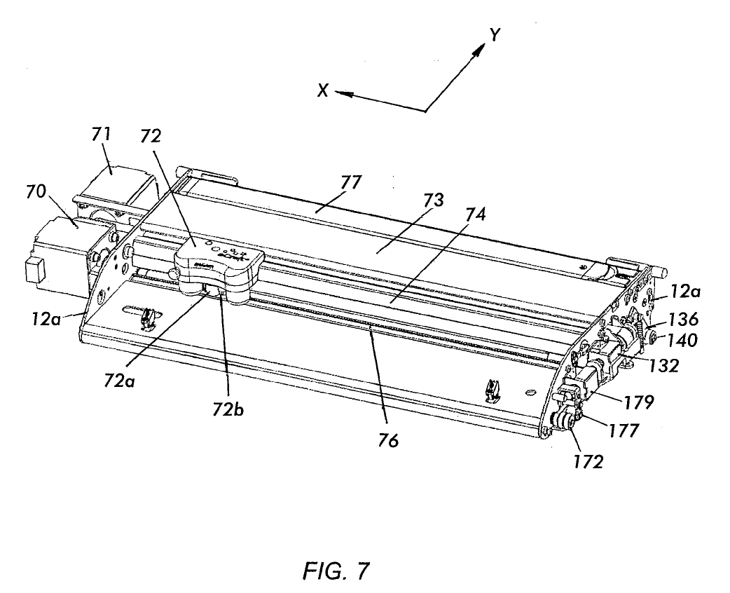

FIG. 7 illustrates operational elements of the device 10 without the housing 12. The operational elements include a paper drive system, or paper driver, that feeds paper into the device 10, drives paper through it, and removes paper out of it. These elements include, but are not limited to, the drive rollers 80, 81, the feed roller 120, check roller 150, front roller 170 and the motors 70, 71. The operational elements also include the operational head 72 used to cut and draw or print on the paper. FIG. 7 illustrates operational head 72, the operational bracket 74 on which the head moves, the cutting surface 76, the motors 70, 71 and a cover 73. FIG. 7 also illustrates a battery 77, which may be used to power the device 10. The elements of FIG. 7 are mounted in the housing 12.

In a preferred embodiment, the device 10 uses two motors 70, 71 to feed paper into the device 10 and to control the operational head 72. The operational head 72 includes both a blade, or other cutting element, 72a for cutting paper and a printing element 72b, such as a pen, for example, for drawing on the paper. It is noted that the device 10 can cut paper and draw, or print, on paper without the need to switch out or otherwise modify the operational head 72. Further, printing and cutting may be performed on the same piece or portion of paper successively.

In operation, paper is moved through the device 10 parallel to the axis Y in FIG. 7 while the operational head 72 moves parallel to the axis X in FIG. 7. As a result, virtually any portion of a piece of paper moving through the device 10 may be cut or printed on, as desired. The motor 70 controls the feeding of paper into the device 10 and driving paper through the device. The motor 71 moves the operational head 72. The operation of these motors is coordinated to position the operational head 72 over the desired portion of the paper at the desired time to allow for cutting or drawing on that portion the paper. Paper is fed into the device 10 either from the tray 14, the paper roll 9, or manually from the front of the device.

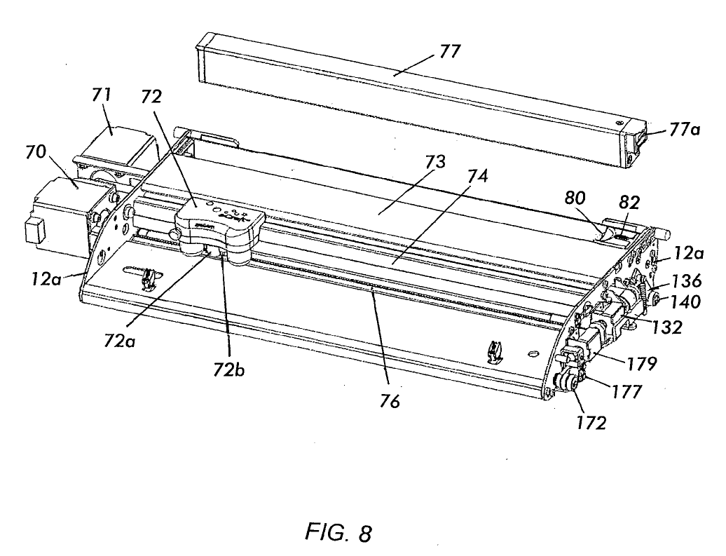

The battery 77 is preferably a lithium ion type rechargeable battery. Suitable contacts 77a are provided to connect the battery 77 to the device 10. In addition, the device 10 preferably includes recharging circuitry (not shown) that allows the battery 77 to be recharged while positioned in the device 10. FIG. 8 illustrates the battery 77 removed from the device 10. In this illustration, the contacts 77a are visible. Corresponding contacts 80 are provided on the device 10. In addition, the device 10 includes a release switch 82 that is operable to release the battery 77 from the device 10 to allow for removal.

FIG. 7 also illustrates a cutting surface 76 on which the paper is cut by the blade 72a. The cutting surface 76 is preferably made of a hard, durable material, preferably a metal, or metal alloy. In a preferred embodiment, a metal alloy including Magnesium (Mn) with a coating of Chromium (Cr) is used for the cutting surface. While a metal alloy is preferred, any suitable hard and durable material may be used including but not limited to tempered glass and hard plastics. Since the operational head 72 moves along the same general path parallel to the X axis, it is possible to provide a rather narrow cutting surface 76, which minimizes material usage. The cutting surface 76 is described in further detail below.

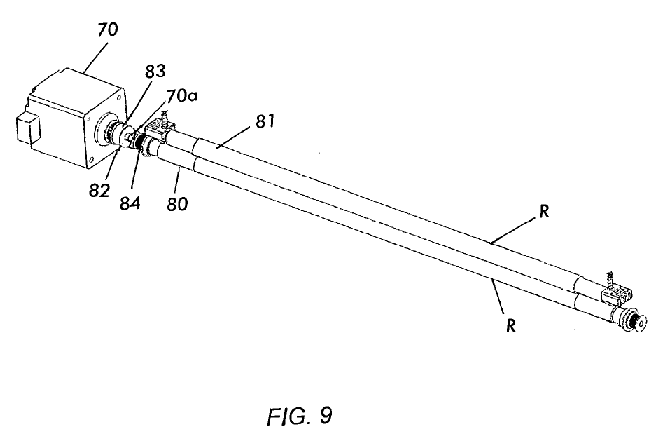

FIG. 9 illustrates how the motor 70 drives primary drive rollers, 80, 81, which drive the paper through the device 10 and under the operational head 72. The drive shaft 70a of the motor 70 includes a gear 82 mounted on the end thereof that rotates with the drive shaft. The gear 82 is in turn connected to a first end of a belt 83. The opposite end of the belt 83 is connected to a gear 84 positioned at an end of primary roller 80. As a result, the roller 80 will rotate as the drive shaft 70a rotates. The rotation of the roller 80 rotates the upper roller 81 as well. Paper is driven through the device 10 and under the operational head 72 between the two rollers 80, 81. In a preferred embodiment, a high friction coating R, such as rubber, is provided over a large portion of the surface of the rollers 80, 81 to grip the paper and pull it through the rollers.

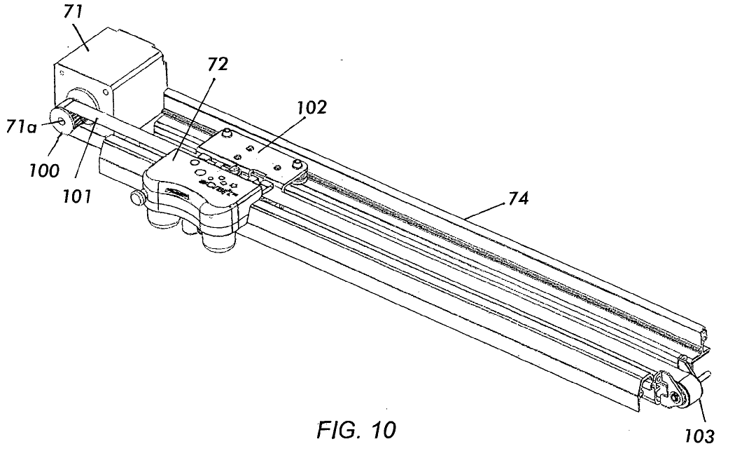

FIG. 10 illustrates how the motor 71 is used to move the operational head 72. The drive shaft 71a of motor 71 preferably includes a head gear 100 that rotates with the drive shaft. A belt 101 is connected at one end to the gear 100. The belt 101 extends across substantially the entire width of the device 10, parallel to the X axis, to a wheel 103 mounted on an opposite end of the device. The operational head 72 is preferably mounted on a trolley 102 connected to the belt 101. The trolley 102 therefore moves with the belt 101. Specifically, the trolley 102 rides along the bracket 74. The operational head 72 is mounted on the trolley 102. The operation of motors 70, 71 is coordinated to coordinate the movement of the paper with that of the operational head 72 to position the operational head as desired to cut or print a desired design or pattern.

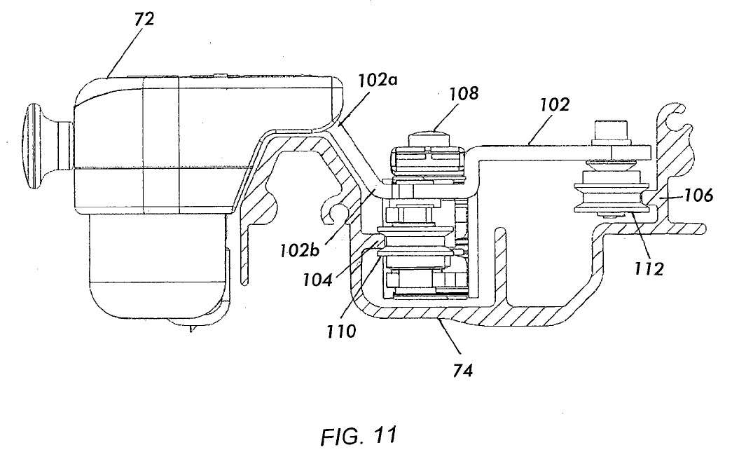

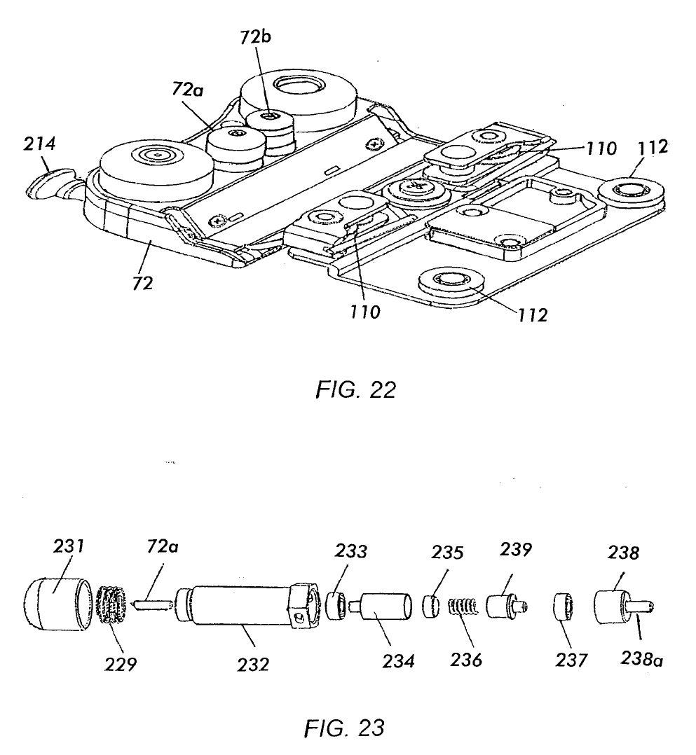

FIG. 11 illustrates a cross sectional view of the bracket 74 with the trolley 102 mounted thereon. A front portion 102a of the trolley 102 includes the operational head 72. A rear portion 102b of the trolley 102 includes two pairs of wheels 110, 112. Only one wheel of the pair is visible in FIG. 11. FIG. 22 provides a clear view of both pairs of wheels 110, 112. The first pair of wheels 110 runs along a first rail 104 of the bracket 74 that extends substantially the entire width of the device 10. A second set of wheels 112 ride along a second rail 106 on the rear of the bracket 74. It is noted that the rear portion 102b of the trolley 102 and the rear of the bracket 74 is not visible in FIGS. 7-8 due to the presence of the cover 73. A fastening mechanism 108 connects the trolley 102 to the belt 101. FIG. 11 illustrates the fastening mechanism as including a screw, however, any suitable fastening mechanism may be used.

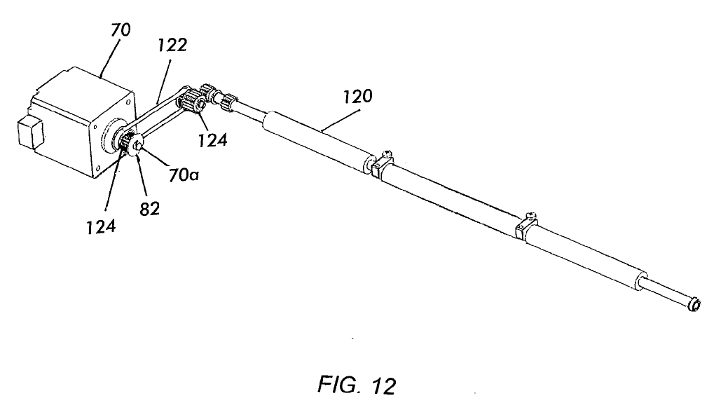

FIG. 12 illustrates a feed roller 120 that is driven by the motor 70. As illustrated, the drive shaft 70a is linked to the feed roller 120 via a feed belt 122. The feed roller 120 is positioned at a rear of the device 10 and serves to pull paper from the tray 14 or roller 9 into the device. In the preferred embodiment of FIG. 12, the belt 122 connects to feed gear 124 on the drive shaft 70a, which is positioned inside the drive gear 82 of FIG. 9. A second end of the belt 122 is connected to intermediate gear 124, which in turn engages the feed roller 120 to rotate the feed roller. While this embodiment is preferred, the belt 122 may be directly linked to the roller 120, if desired.

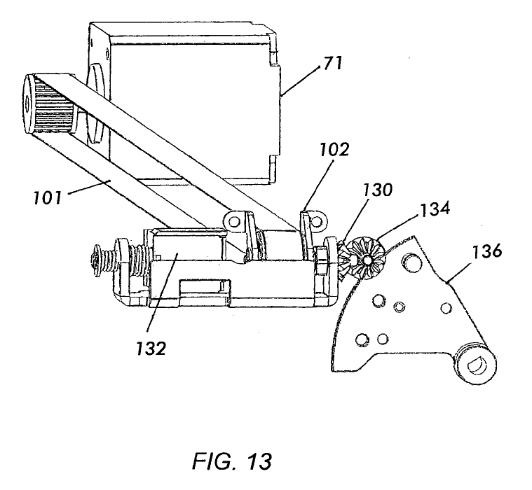

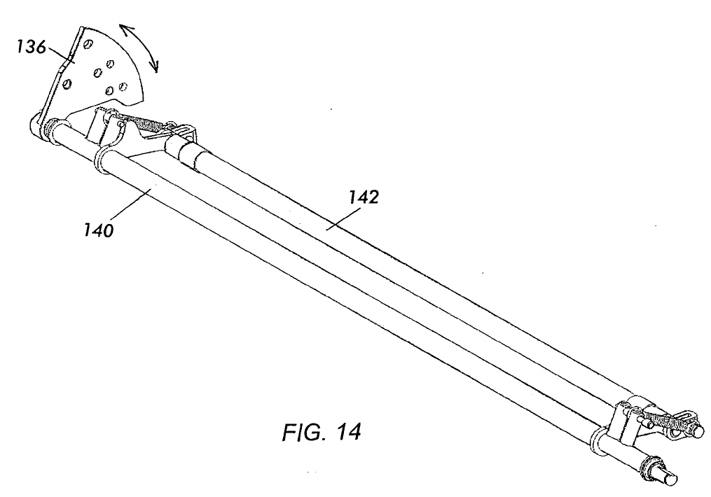

FIG. 13 illustrates how paper is lifted up in the tray 14 to be fed into the device 10. As illustrated, the wheel 103, driven by motor 71 via the belt 101, rotates the cone gear 130. The solenoid 132 is active to selectively move the cone gear 130 into and out of contact with tapered gear 134. While a solenoid 132 is illustrated, any suitable actuator may be used to selectively move the cone gear 130 into and out of contact with the tapered gear 134. The tapered gear 134 transfers the torque of the cone gear 130 to the arm 136 which rotates up and down a finite amount FIG. 14 illustrates the opposite end of the arm 136. The arm 136 is connected to the pivot bar 140 which rotates with the arm. A lift bar 142 is connected to the pivot bar 140 and moves therewith. The lift bar 142 is positioned at a rear of the device 10 and is positioned under the paper in the tray 14 and the guide 14a. Thus, when the lift bar 142 rises, it lifts the paper up to be fed into the device 10. The lift bar 142 lifts the paper up to contact the feed roller 120 discussed above. The guide 14a lifts up with the lift bar 142 to ensure that the paper is substantially flat as it enters the device. Without the guide 14a, the paper would tend to bend as it was lifted up to feed roller 120. This bending tends to increase the likelihood of a paper jam.

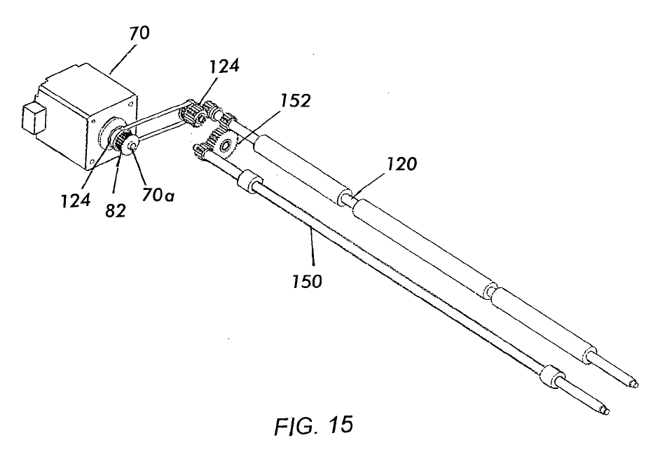

FIG. 15 illustrates a more detailed view of FIG. 12 in which a counter-rotating check roller 150 that coordinates with the feed roller 120 is shown. As illustrated, a counter gear 152 is provided between the roller 120 and the check, or counter roller 150. As illustrated, the counter gear 152 is driven by the feed roller 120 and rotates the check roller 150 in a direction opposite that of the feed roller 120. The check roller 150 thus prevents two pages from being fed into the device 10 at the same time.

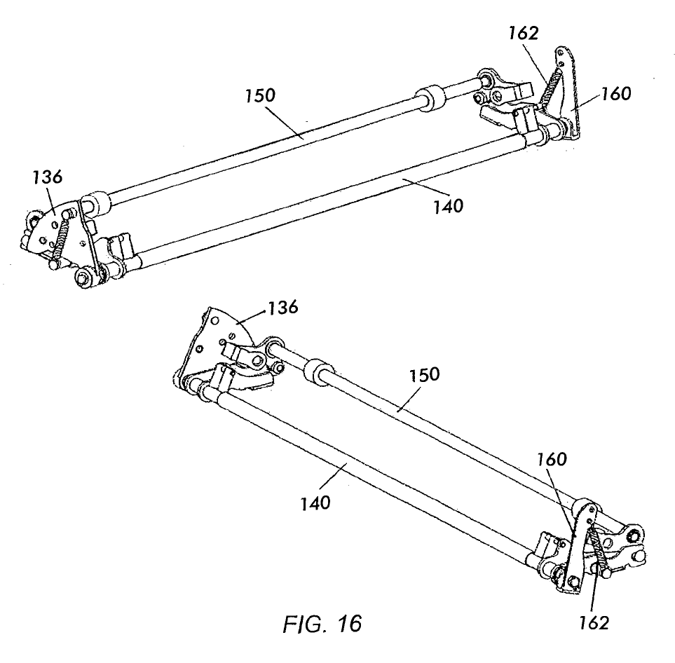

FIG. 16 illustrates how the arm 136 may also be used to raise and lower the check roller 150, as desired. The check roller 150 is only needed when paper is being fed into the device 10. Thus, the check roller 150 may be raised up into contact with the counter gear 152 by operation of the arm 136 which is also used to raise the lifting bar 142 to aid in the feeding of paper into the device 10. As can be seen in FIG. 16, therefore, the rotation of the pivot bar 140 may also be used to raise the check roller 150. The spar 160 and spring 162 opposite the arm 136 are intended to transfer lifting power of the arm 136 to the opposite side of the pivot bar 140 such that even lifting occurs.

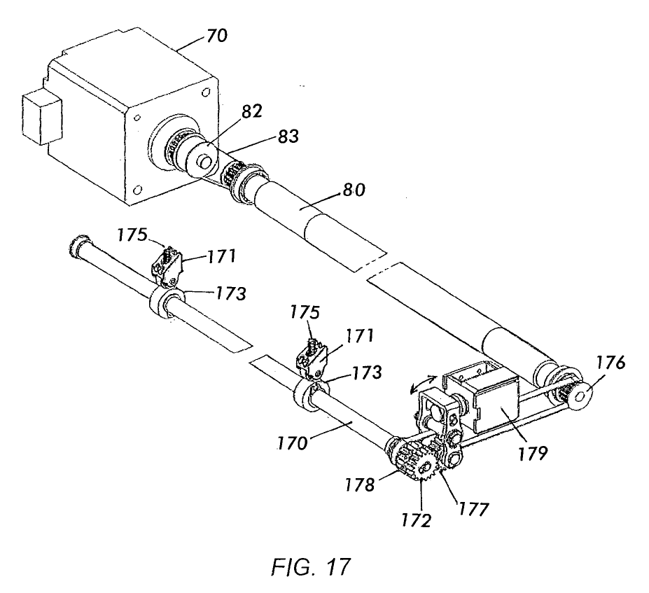

FIG. 17 illustrates operation of a front roller 170 which is provided both to pull paper out of the device 10 after work is completed and to allow for paper to be fed into the device from the front. The front roller gear 172 rotates the front roller 170. A belt 174 is connected on one end to a feed gear 176 positioned at the end of the drive roller 80. The other end of the belt 176 is connected to the drive gear 178, which rotates when the feed roller 80 rotates. The drive gear 178, however, does not rotate the front roller 170. Instead, the solenoid 179 is provided to selectively move intermediate gear 177 into and out of contact with the gears 172 and 178. When the gear 177 is in contact with the gear 178, it rotates, and, in turn, rotates the front roller gear 172 to rotate the front roller 170. When the gear 177 is removed from contact with the gear 178, there is no rotation of the front roller 170. Thus, the front roller 170 is selectively rotatable via operation of the solenoid 179. While a solenoid 179 is illustrated, any suitable actuator may be used.

Specifically, as the front roller 170 rotates, the rings 173 formed on the front roller 170 extend up through the housing 12 to contact the paper and move it. The wheels 171 are mounted above the rings 173 in a top portion of the housing 12 and the paper is between them. Biasing springs 175 are positioned above the wheels 171 to push them downward toward the rings 173. The rings 173 may be coated with a relatively high friction material, such as rubber, to grip the paper and move it if desired.

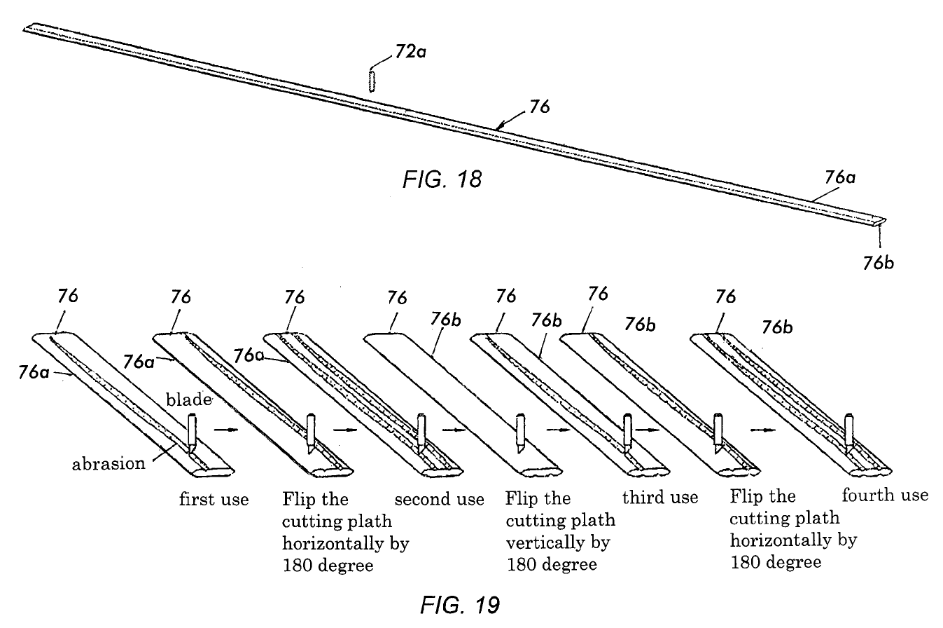

FIG. 18 illustrates the cutting surface 76. As illustrated, the cutting surface 76 may be embodied as a long strip of material that extends substantially the width of the device 10. The blade 72a is shown over the cutting surface 76. The blade 72a always cuts on the cutting surface 76. The cutting surface 76 is preferably made of a durable and hard metal, or metal alloy that is resistive to cracking, flaking or scratching, as is noted above. In a preferred embodiment, the cutting surface 76 includes a first element 76a with a first cutting surface and a second element 76b with a second cutting surface. The two elements 76a, 76b are preferably connected together. In a preferred embodiment, a rubber filling material is provided between the first and second elements 76a, 76b to absorb shock. This reduces wear on the cutting surface. In a preferred embodiment, the rubber filling material may be magnetic, and thus, may be used to hold the first and second elements 76a, 76b together.

As can be seen in FIG. 19, in a preferred embodiment, the cutting surface 76 is aligned with the cutting element, or blade, 72a such that cutting occurs adjacent to an edge of the cutting surface. While the cutting surface 76 is very durable, over time, the surface may become worn, as illustrated in FIG. 19. This is especially true since cutting always occurs on the same area of the cutting surface 76. In a preferred embodiment, however, the cutting surface 76 is removably mounted in the device 10 to allow for the surface to be turned and flipped in order to align the blade 72a with a clean portion of the surface once one surface gets worn. In total, the surface 76 can be adjusted 4 times to provide a clean surface for cutting. First the cutting surface 76 may be turned horizontally 180 degrees such that the opposite edge of the same surface is aligned with the blade 72a. Next, the cutting surface 76 may be rotated to the opposite side to use the second surface 76b, for example. Then the cutting surface 76 can be turned again horizontally 180 degrees such that the opposite edge of the second side of the cutting surface 76 is aligned with the blade 72a. This further extends the life of the cutting surface 76. The turning and flipping of the cutting surface 78 is illustrated in FIG. 19.

The cutting surface 76 is an important improvement over the prior art in this area since it eliminates the need for the cutting mats commonly used therein. In the device 10, there is no need for a cutting mat since the blade 72a always cuts on the dedicated cutting surface 76 built into the device 10. This significantly increases productivity and ease of use and also reduces costs associated with the device 10 since there is no need to constantly replace cutting mats. Further, it is easier and faster to load paper into the device 10 since there is no need to mount it on a cutting mat first. In fact, as noted above, paper can be automatically loaded into the device 10 from the tray 14 or the roll 9, as desired. The paper that is loaded into the device 10 is unsupported prior to entering the device. In contrast, in the prior art devices, paper must be mounted on and supported by a cutting mat external from the device and then the supported paper is fed into the device.

One of the other benefits of the device 10 in comparison to the prior art is that the operational head 72 allows the user to cut and write on paper without the need to adjust the head manually. In the prior art, in order to write, a user had to remove the blade and replace it with a writing instrument. This is inconvenient, time consuming and generally inefficient. Further, where a design includes both drawn elements and cutting, it is difficult to realign the head to accurately cut the design after it is drawn on, if the head needs to be modified to replace the blade with a writing implement.

In contrast, the operational head 72 of the present application provides a blade, or other cutting element, 72a and a printing element 72b. This allows the user to both write on and cut a design without having to adjust the operating head at all. Further, by providing the blade and printing element in the same head, alignment of a printed design and a cut design is simplified since the drawing and cutting are performed in one operation.

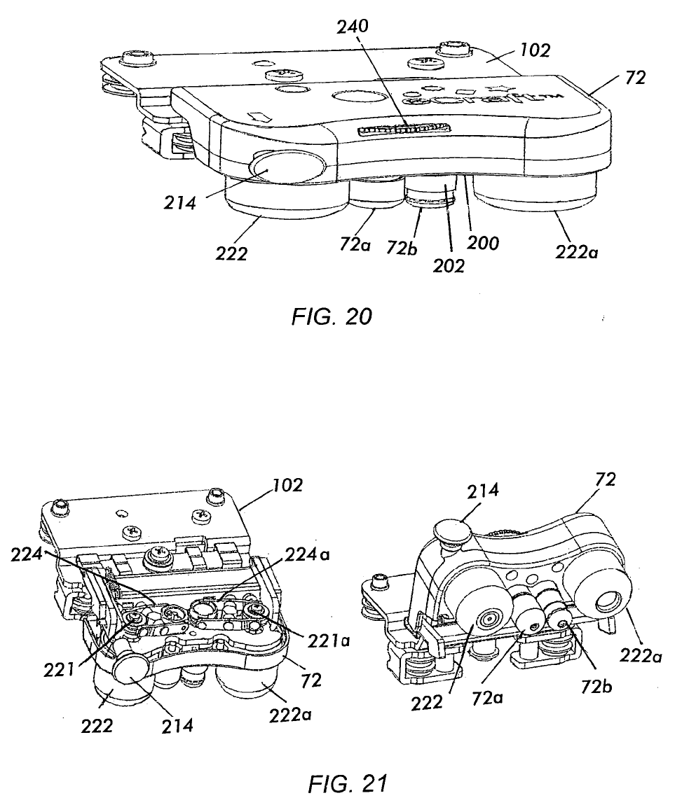

FIG. 20 illustrates a more detailed view of the operational head 72. As illustrated, the head 72 includes a blade slot 200 and a printing element slot 202. The blade 72a is mounted to be moved up and down in the blade slot 200 and the printing element 72b moves up and down in the printing element slot 202. FIG. 21 also illustrates a blade adjustment knob 240, which may be used to adjust the height of the blade 72a relative to the cutting surface 76. A window 72c may be provided in a top of the head 72 to illustrate to the user the position that the knob 240 is set at. In addition, a light element 72d may be mounted in the head 72. The light element is preferably configured to emit light when the blade 72a contacts the cutting surface 76. This signals to the user that the blade 72a is cutting all the way through the paper.

In a preferred embodiment shown in FIG. 21, for example, the entire operational head 72 is preferably mounted on the trolley 102 such that it is pivotable upward to allow easy access to the blade 72a and the printing element 72b. Pulling out the tab 214, which unlocks the operational head 72 for pivoting upward, provides the pivoting action.

FIG. 22 shows the bottom of the operational head 72 along with the trolley 102 on which it is mounted. The two pairs of wheels 110, 112, which ride on the rails 104, 106 of bracket 74, are more clearly visible in this view.

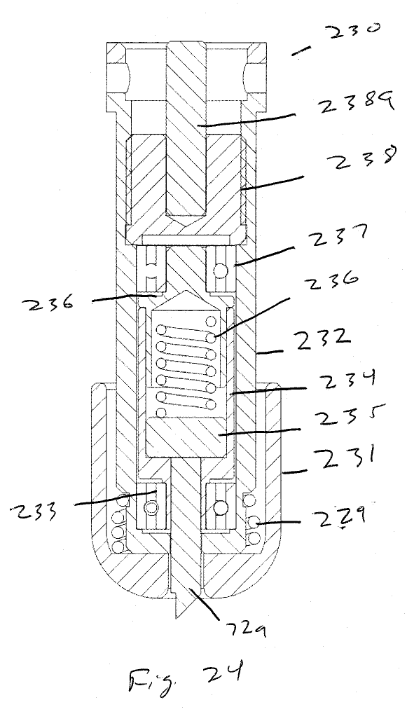

FIG. 23 illustrates an exploded view of a blade assembly 230 in which the blade 72a is mounted. More specifically, it is the entire assembly 230 that moves up and down in the slot 200 to move the blade into and out of contact with the paper. In a preferred embodiment, a cap 231 is provided at a distal end of the assembly 230. The cap 231 covers the blade 72a for safety when not in use. A spring 229 biases the cap 231 downward with respect to assembly housing 232, but yields upward during use. A bearing 233 is provided between the housing 232 and a blade carrier 234. The blade 72a is inserted into an opening in the distal end of the carrier 234 and is held in place by magnet 235. The magnet 235 is biased downward by the inner spring 236, which also acts as a shock absorber. The end of the blade 72a, magnet 235 and the spring 236 are all mounted in the carrier 234. An inner cap 239 is provided to enclose these elements in the carrier 234. A bearing 237 is provided above the inner cap 236 such that the carrier 234, including the blade 72a is freely rotatable relative to the housing 232. As adjustment element 238 is provided above the bearing 237. The adjustment element 238 preferably includes an outer thread such that its position relative to the bearing 237 may be adjusted to vary the height of the blade 72a relative to the cutting surface 76. FIG. 24 illustrates a cross sectional view of the assembly 230. The blade 72a is preferably made of steel, and thus, is very strong and durable. As mentioned above, replacement blades may be stored in the drawer 30.

While the present disclosure specifically refers to a cutting blade 72a, any suitable cutting element may be used to cut the paper as desired by the user.

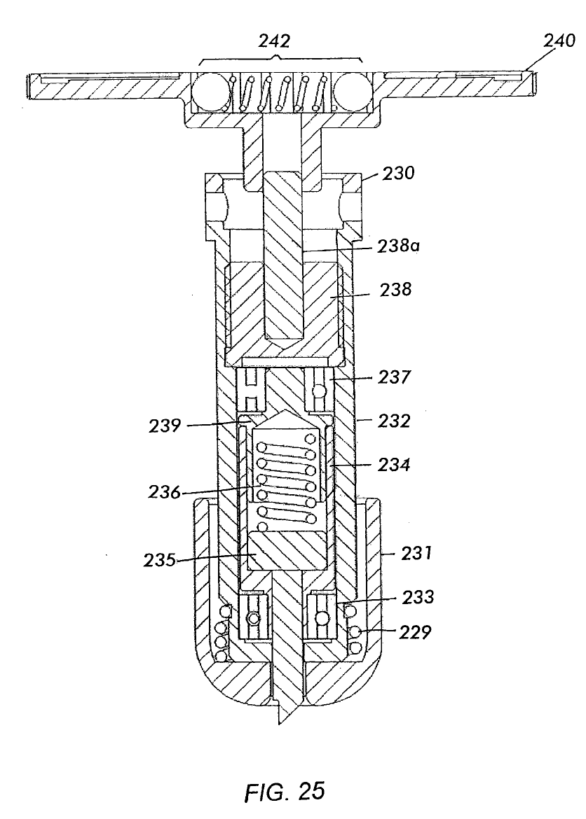

In a preferred embodiment, rotation of the shaft 238a will result in adjustment of the vertical position of the adjustment element 238, and thus, the vertical position of the blade 72a. The adjustment knob 240 illustrated in FIG. 25, for example, may be used to make this adjustment. The entire assembly 230 is mounted in the slot 200 of the operational head 72 and is movable up and down as desired.

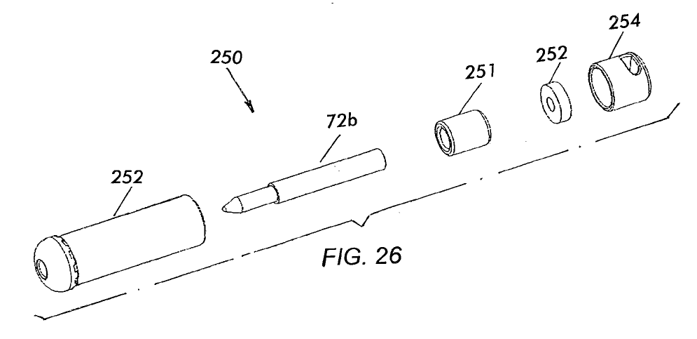

More specifically, the assembly 230 is moved up and down by action of a solenoid 221 mounted in the housing 222 of the operational head 72. See FIG. 21, for example. The solenoid 221 in turn actuates the arm 224, which in turn moves, the assembly 230 upward and downward, toward and away from the cutting surface 76. A second solenoid 221a is provided is corresponding housing 222a and connected to arm 224a to move the printing element assembly 250 (see FIG. 26) in a similar manner.

FIG. 25 illustrates the blade assembly 230 with the addition of the blade adjustment knob 240. The knob rotates the shaft 238a to adjust the relative height of the blade 72a. In a preferred embodiment, the locking mechanism 242 provided in the knob 240 provide for a finite number of set positions to which the blade height may be adjusted. In a preferred embodiment, there are 16 finite positions that the knob 240 may be set to which corresponds to a total of a 1 mm change in blade height. If desired, however, the blade 72a may be adjusted to other heights and additional or fewer positions may be provided.

FIG. 26 is an exploded view of the printing element assembly 250. The printing element 72b, which is illustrated as a pen in FIG. 26, is mounted in the lower housing 252. In a preferred embodiment, the pen 72b is held in the assembly 250 via a magnet 252 and is moved up and down by the arm 224a discussed above. A cap 254 is provided above the magnet 252. A centering ring 251 keeps the pen 72b centered in the housing 252. The pen may include ink of any desired color and replacement pens and pens of other colors may be stored in the drawer 30. While the printing element 72b is illustrated as a pen, any suitable writing implement may be used.

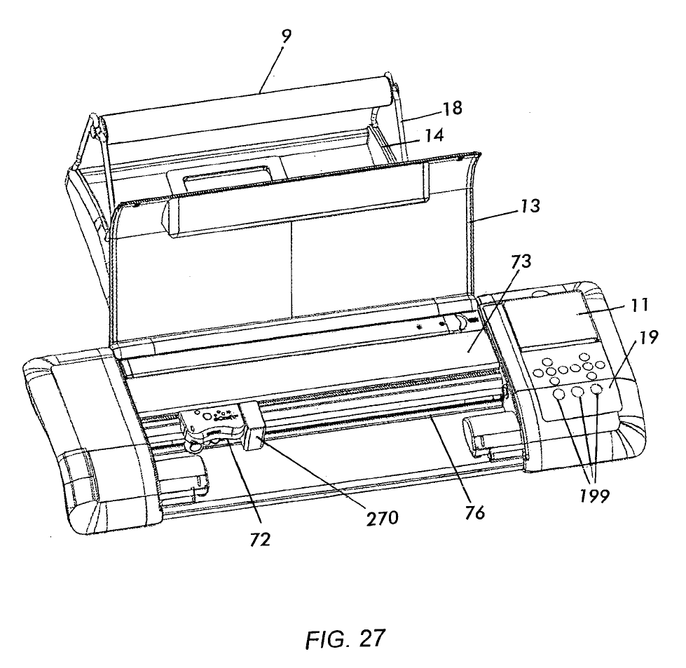

FIG. 27, for example, illustrates an alternative embodiment of a cutting device in accordance with the present disclosure in which the operational head 72 is paired with an inkjet print head 270. In this embodiment, the blade 72a works in the operational head 72 in substantially the same manner as described above, however, the printing element is embodied by the inkjet print head 270. The inkjet print head 270 is preferably of a type commonly used in inkjet printers. Otherwise the device of FIG. 27 works in substantially the same manner as described above.

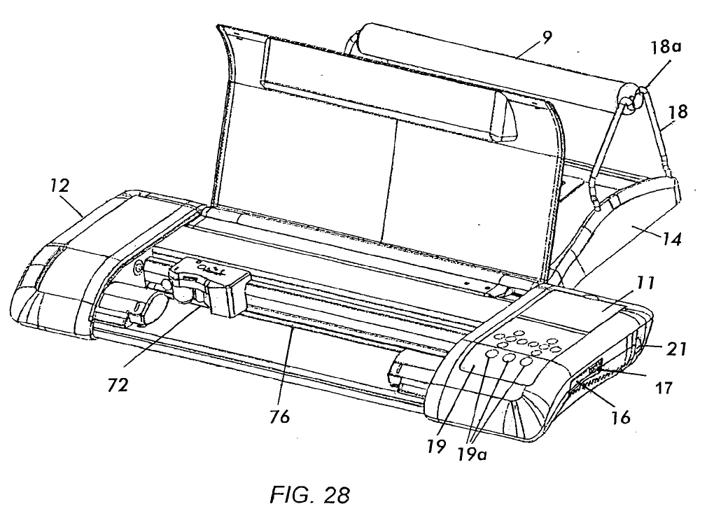

In FIG. 28, an alternative embodiment is illustrated in which the operational head 72 includes an integral inkjet print head such that the inkjet head essentially replaces the printing element 72b.

In operation, the device 10 is preferably operable in 3 different modes. The user may set the desired mode utilizing the input buttons 19a. The input buttons 19a may also be used to select a desired design, the number of the desired designs to be cut and the size of the design. That is, the user may select, for example, five hearts each of which having a size of 3 inches to be cut from the paper by the device 10. The user may also set more than one design to be cut from a piece of paper. That is the user may select, for example, three, three inch hearts followed by three, four inch circles if desired.

In addition, there is an option to provide tabs in the cut design. That is, there is an option to leave small portions of the design uncut such that the paper remains substantially intact even as the design is cut. This allows paper to be easily fed out of the device 10 in one piece and also reduces the likelihood of a paper jam. After the design has been cut, the paper is fed out of the device 10 with the front roller 170, for example, and the user can separate the tabs by hand to release the design from the rest of the paper. The width of each tab, and the number of tabs left per design may be selected by the user using the buttons 19a.

This feature is particularly useful in the device 10 since no cutting mats are necessary. The cutting mats required in the prior art devices keep the cut design and the waste paper together until they are fed out of the device so there is no paper jam or damage done to the designs. Since the device 10 of the present disclosure does not require the cutting mats, the tabs serve to keep the cut design with the waste paper until they exit the device. They can then be easily separated by the user.

The buttons 19a also allow the user to select the orientation of the design on the page, preferably, either portrait or landscape. The user may also use the buttons 19a to select multiple designs to be cut out one after the other, as noted above.

In a first mode, MANUAL, paper is loaded into the device from the front via the front roller 170 described above. A user may lift the cover 13 to align the blade 72a where desired and then proceed to activate the device 10 to cut the selected design. The operational head 72 may be adjusted in position using button 19a to move the head and/or to move the paper under the head, if desired. When the design is cut, the paper is pulled out of the device 10 using the front roller 170 in the manner described above. In a preferred embodiment, the front roller 170 advances the paper completely out of the device 10. While the device 10 does not require a cutting mat, a cutting mat may be used in the MANUAL mode.

In a second mode, TRAY, the device 10 will automatically feed paper from the tray 14 into the device. The user may again set the desired design, number, size, tab number and size and orientation of the design on the paper. The device 10 will automatically maximize paper use in the TRAY mode. That is, based on the number and size of the selected design, the device 10 will automatically cut the designs in the manner in which the least amount of paper is consumed. This option may be disabled if desired. The device 10 will also automatically feed in additional paper as necessary from the tray 14 to complete the desired job. In this mode, it is preferable that all sheets of paper in the tray 14 are of a common predefined size. The device 10 is illustrated as suitable for use with 12″ by 12″ sheets of paper, however, the device 10 is not limited to this size may be built to accommodate larger sizes if desired. Indeed, a larger model suitable for use with 30 inch wide paper common in industrial applications would work in a similar manner.

In the third mode, ROLL, paper is fed into the device 10 from the roller 9. The user is again provided with the option of setting the design, number of copies, and size as well as the orientation of the design. Based on this information, the device will advance the paper from the roller 9 into the device 10. Initially a suitable length of paper to accommodate the desired job is fed into the device 10 from the roller 9, then the device will start cutting. In this manner, the user can make extended banners and the like. In a preferred embodiment, the input buttons 19a also include a button that will trigger the blade 72a to simply cut straight across the paper at a desired point. Thus, after the desired design has been cut, or drawn, on the paper from the roller 9, the paper including the design may be cut away from the remaining uncut paper on the roll of paper. This paper may then be advanced out of the device 10 by the front roller 170 as described above.

In any of the above modes, the device 10 may utilize the printing element 72b to draw or print an image or other indicia on the paper. It is noted that since the head 72 includes the printing element 72b, the printing can be accomplished without modifying the head. Further, printing with the printing element 72b may be accomplished immediately before cutting by the blade 72a while the paper remains in the device 10. In a preferred embodiment certain designs that are selected by the user may include printed elements and these printed elements are automatically provided by the device 10.

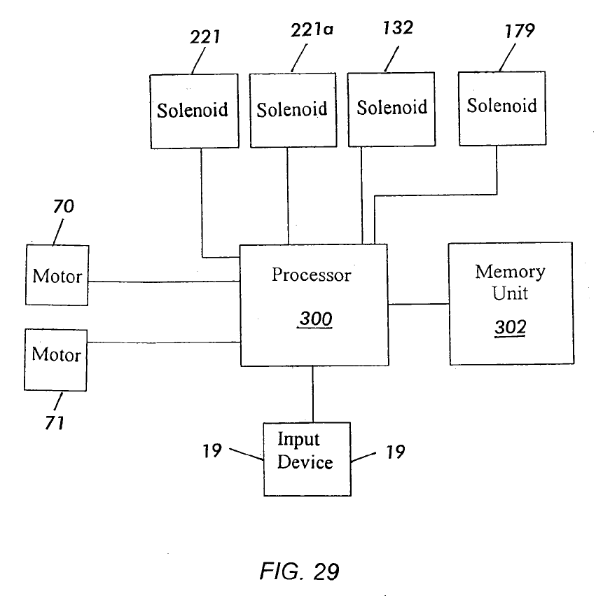

The input buttons 19a of the input device 19 are preferably connected to a processor 300 that controls the device 10. FIG. 29 illustrates a simplified block diagram illustrating the processor 300 and how it controls the device 10. As illustrated, the processor 300 controls the motors 70, 71 to control movement of paper through the device 10 and movement of the operational head 72. This includes movement of the head 72 back and forth parallel to the X axis. The processor 300 also controls the solenoids 221, 221a to move the assemblies 230, 250 up and down to cut and print on paper. The processor 300 further controls the solenoids 132 and 179 to control feeding of the paper into the device and removal of the paper from the device as well. A memory device 302 may be connected to the processor 300, or integral therewith. The memory device 302 stores information regarding the parameters set by the user using input buttons 19a. The memory 302 also stores instructions for operating in the three modes described above. The memory unit 302 may also store design data obtained from the removable media or via the USB port as well. The design data preferably includes a set of instructions required to cut the desired designs. These instructions preferably include instructions to control the movement of the paper and the operational head to provide the desired designs cut from or drawn on the paper.

While the term processor is used, the processor 300 may be embodied by any suitable control device or circuit. The processor may be, or include, a microprocessor or other similar device and/or be embodied in dedicated firmware or as an integrated circuit.

The cutting device 10 of the present application thus includes many advantages unavailable in prior art devices. First, the dedicated cutting surface 76 is used for all cutting. This cutting surface 76 is made of a hard and durable metallic alloy, or other material that is long lasting. As a result, there is no need for the cutting mats that are generally required by the prior art cutting devices.

Further, the device 10 allows paper to be automatically fed into the device from the tray 14 as need. In addition, paper can be automatically fed into the device 10 from the roller 9, as well. No other cutting device provides for these automatic feeding options.

The operational head 72 includes both a cutting blade 72a to cut paper and a printing element 72b to allow the device to write or draw on the paper as well. No other cutting device allows for drawing unless the blade is removed and replaced with a printing element. The operational head 72 is also easily adaptable to include an inkjet print head as well.

In addition, the device 10 allows for the user to select a size and number of tabs to be included on the cut design such that the cut design portion of the paper, at least temporarily, remains with the paper even after being cut. No other device provides for tabs at all, much less the ability to select the number and width of such tabs

Thus, the cutting device 10 of the present disclosure provides numerous advantages over conventional paper cutters, which dramatically increase ease of use, efficiency and productivity.

Although the present invention has been described in relation to particular embodiments thereof, many other variations and modifications and other uses will become apparent to those skilled in the art.

What is claimed is:

1. A cutting device comprising:
an operational head including a cutting element mounted thereon; and
a cutting surface for receiving and supporting unsupported paper, the operational head configured to move relative to the paper supported by the cutting surface to cut a desired pattern therein with the cutting element.

2. The cutting device of claim 1, further comprising a printing element to print on the paper.

3. The cutting device of claim 2, wherein the printing element is mounted on the operational head.

4. The cutting device of claim 1, further comprising:
a paper tray configured to hold a plurality of pieces of unsupported paper; and
a paper feeder configured to feed paper to the cutting device from the paper tray.

5. The cutting device of claim 1, further comprising:
a paper roller configured to hold a roll of paper; and
a paper feeder configured to continuously feed paper to the cutting device from the roll of paper until the desired pattern is cut.

6. The cutting device of claim 1, wherein the cutting element is a cutting blade and the operational head selectively lowers the cutting blade to cut the paper on the cutting surface to cut the desired pattern.

7. The cutting device of claim 6, wherein the operational head selectively raises the cutting blade while cutting the paper on the cutting surface to provide tabs of uncut paper in the desired pattern.

8. A method for cutting paper comprising the steps of:
feeding unsupported paper into a paper cutting device;
supporting the unsupported paper after it has been received in the paper cutting device; and
cutting the supported paper to provide a desired pattern therein.

9. The method of cutting paper of claim 8, further comprising the step of printing on the paper.

10. The method of cutting paper of claim 8, wherein the feeding step further comprises feeding paper from a paper tray into the cutting device.

11. The method of cutting paper of claim 8, wherein the feeding step further comprises continuously feeding paper from a roll of paper into the cutting device until the desired pattern is cut.

12. The method of cutting paper of claim 8, wherein the cutting step further comprises leaving uncut tabs of paper in the desired pattern.

13. A cutting device comprising:
an operational head configured to move to a desired position in the cutting device;
a cutting surface positioned under the operational head;
a paper driver configured to drive paper through the cutting device between the operational head and the cutting surface;
wherein, the operational head further includes at least one cutting element configured to selectively cut the paper on the cutting surface to provide a desired pattern; and
a processor configured to control the operational head and the paper driver to position the operational head at the desired position over a desired portion of the paper.

14. The cutting device of claim 13, wherein the paper driver includes at least one roller configured to rotate to drive the unsupported paper through the cutting device.

15. The cutting device of claim 14, wherein the paper driver includes a first motor configured to drive the roller.

16. The cutting device of claim 14, further comprising a paper tray connected to the cutting device and configured to hold a plurality of pieces of unsupported paper.

17. The cutting device of claim 16, wherein the paper driver further comprises a feed roller positioned adjacent to the paper tray and configured to rotate to feed unsupported paper from the paper tray to the roller in the cutting device.

18. The cutting device of claim 17, wherein the feed roller automatically feeds a second piece of unsupported paper from the paper tray to the roller in the cutting device when desired to complete the desired pattern.

19. The cutting device of claim 17, further comprising:
a pair of brackets extending upward from the paper tray; and
a paper roller configured to rotate on the pair of brackets, the paper roller including a roll of paper.

20. The cutting device of claim 19, wherein the feed roller feeds paper from the roll of paper to the roller in the cutting device when desired to complete the desired design.

21. The cutting device of claim 14, wherein the paper driver further comprises a forward roller positioned in front of the roller, the front roller configured to rotate in a first direction to pull paper out of the cutting device based on instructions from the processor.

22. The cutting device of claim 21, wherein the front roller rotates in a second direction, opposite the first direction, to feed paper to the roller in the cutting device based on instructions provided by the processor.

23. The cutting device of claim 13, further comprising a second motor configured to move the operational head.

24. The cutting device of claim 13, wherein the cutting element is a cutting blade and is movable toward the cutting surface to cut the desired pattern, the cutting blade mounted in the operational head to rotate as necessary to cut the desired pattern in the paper.

25. The cutting device of claim 24, wherein the operational head further comprises an adjustment device operable to adjust a height of the cutting blade relative to the cutting surface.

26. The cutting device of claim 24, wherein the operational head further comprises a light source configured to emit light when the cutting blade contacts the cutting surface to indicate that the cutting blade is cutting completely through the paper.

27. The cutting device of claim 13, further comprising a printing element mounted in the operational head, the printing element movable up and down in the operational head to selectively draw on the paper based on instructions provided by the processor.

28. The cutting device of claim 27, further comprising an input device configured to allow a user to input information regarding the desired pattern and to provide the information to the processor.

29. The cutting device of claim 13, further comprising a media slot configured to receive a data storage device including information regarding the desired pattern and to provide the information to the processor.

30. The cutting device of claim 13, further comprising a data port configured to receive a data cable providing information regarding the desired pattern and to provide the information to the processor.

31. The cutting device of claim 13, further comprising an internal power supply configured to power the cutting device.

32. The cutting device of claim 13, wherein the cutting surface comprises a first surface and a second surface opposite the first surface.

33. The cutting device of claim 32, wherein the cutting surface is removably mounted in the cutting device with the first surface facing the operational head and configured for removal and reinsertion in the cutting device with the second surface facing the operational head.

34. A cutting device comprising:
an operational head movable to a desired position in the cutting device;
a cutting surface positioned under the operational head;
a paper driver configured to drive paper through the cutting device between the operational head and the cutting surface;
wherein, the operational head further comprises:
at least one cutting element configured to selectively cut the paper on the cutting surface to provide a desired pattern; and
at least one printing element configured to selectively draw on the piece of paper; and
a processor operable to control the operational head and the paper driver to position the operational head in the desired position over the paper and to control the operation of the at least one cutting element and the at least one printing element.

35. The cutting device of claim 34, wherein the printing element is a pen mounted in the operational head to move up and down to selectively draw on the piece of paper based on instructions from the processor.

36. The cutting device of claim 34, wherein the printing element is an inkjet print head controlled by the processor to selectively draw on the piece of paper.

37. The cutting device of claim 36, wherein the cutting element is a cutting blade selectively movable toward the cutting surface to cut the desired pattern.

38. A cutting device comprising:
an operational head movable to a desired position in the cutting device;
a cutting surface positioned under the operational head;
a paper driver configured to drive paper through the cutting device between the operational head and the cutting surface;
a paper tray configured to hold a plurality of pieces of paper;
wherein the paper driver further comprises:
a feed roller positioned adjacent to the paper tray and configured to rotate to automatically feed the paper into the cutting device from the paper tray; and
wherein, the operational head further includes at least one cutting element configured to selectively cut the paper on the cutting surface to provide a desired pattern; and
a processor operable to control the operational head and the feed roller to respective desired positions and to operate the cutting element to selectively cut the piece of paper in the desired pattern.

39. The cutting device of claim 38, further comprising:
a pair of brackets extending upward from the paper tray; and
a paper roller configured to rotate on the pair of brackets, the paper roller comprising a roll of paper.

40. The cutting device of claim 38, wherein the feed roller automatically feeds paper from the roll of paper into the cutting device when desired.

41. A cutting device comprising:
an operational head movable to a desired position in the cutting device;
a cutting surface positioned under the operational head;
a paper driver configured to drive paper through the cutting device between the operational head and the cutting surface;
wherein the operational head further comprises:
at least one cutting element configured to selectively cut the paper on the cutting surface to provide a desired pattern;
a processor configured to control the operational head and the paper driver to position the operational head in the desired position over the paper; and
an input device configured to enable a user to provide information to the processor regarding a desired pattern.

42. A cutting device comprising:
an operational head configured to move to a desired position in the cutting device;
a cutting surface positioned under the operational head;
a paper driver configured to drive paper through the cutting device between the operational head and the cutting surface; and
a processor configured to control the operational head and the paper driver to position the operational head at the desired position over a desired portion of the paper; wherein,
the operational head further at least one cutting element configured to selectively cut the paper on the cutting surface to provide a desired pattern, and
wherein the processor controls the at least one cutting element to provide a predetermined number of uncut tabs of paper in the desired pattern.

43. A method of cutting paper utilizing a cutting device comprising the steps of:
operating a paper driver to drive paper through the cutting device;
moving an operational head to a desired position over the paper;
providing an integral cutting surface under the operational head and the paper; and
lowering a cutting blade from the operational head to cut the paper at the desired position based on instructions provided by a processor to provide a desired pattern.

44. A method of cutting and printing on paper utilizing a cutting device comprising the steps of:
operating a paper driver to drive paper through the cutting device;
moving an operational head to a desired position over the paper;
providing an integral cutting surface under the operational head and the paper;
lowering a cutting blade from the operational head to cut the paper at the desired position based on instructions provided by a processor to provide a desired pattern; and
printing on the paper using a printing element based on instructions provided by the processor.

45. A method of cutting paper utilizing a cutting device comprising the steps of:
providing a paper tray including a plurality of pieces of paper;
operating a paper driver to feed paper from the paper tray into the cutting device and drive paper through the cutting device;
moving an operational head to a desired position over the paper;
providing an integral cutting surface under the operational head and the paper; and
lowering a cutting blade from the operational head to cut the paper at the desired position based on instructions provided by a processor to provide a desired pattern.

46. A method of cutting paper utilizing a cutting device comprising the steps of:
providing a bracket supporting a roll of paper;
operating a paper driver to feed paper from the roll of paper into the cutting device and to drive paper through the cutting device;
moving an operational head to a desired position over the paper;
providing an integral cutting surface under the operational head and the paper; and
lowering a cutting blade from the operational head to cut the paper at the desired position based on instructions provided by a processor to provide a desired pattern.

47. A method of cutting paper utilizing a cutting device comprising the steps of:
operating a paper driver to drive paper through the cutting device;
moving an operational head to a desired position over the paper;
providing an integral cutting surface under the operational head and the paper;
lowering a cutting blade from the operational head to cut the paper at the desired position based on instructions provided by a processor to provide a desired pattern; and
raising the blade selectively while cutting the desired pattern to provide uncut tabs of paper in the desired pattern.

48. A method of printing on paper utilizing a cutting device having an operational head with a cutting element and a printing element, the method comprising the steps of:
operating a paper driver to drive the paper through the cutting device;
moving the operational head to a desired position over the paper; and
printing on the paper using a printing element based on instructions provided by a processor.
